(19) United States
(12) Patent Application Publication
(10) Pub. No.: US 2017/0127823 A1
(43) Pub. Date: May 11, 2017

(54) MOBILE DEVICE SUPPORT WITH MOVEABLE WEIGHT

(71) Applicant: Evan Bingham Grove, New York, NY (US)

(72) Inventor: Evan Bingham Grove, New York, NY (US)

(21) Appl. No.: 14/937,563

(22) Filed: Nov. 10, 2015

(51) Int. Cl. A47B 23/04

(52) U.S. Cl. CPC A47B 23/04; A47B 23/043; F16M 2200/04; F16M 2200/08

(57) ABSTRACT

A mobile device support is provided herein. The support may include a support element that supports a mobile device and a multi-positionable base on which the support element is mounted. The base may include a first base surface disposed at a first angle with respect to the support element. The first base surface is operable to rest on an underlying surface to position the support element at the first angle while the mobile device is supported on the support element. The base may include a second base surface disposed at a second angle with respect to the support element. The second base surface is operable to rest on the underlying surface to position the support element at the second angle while the mobile device is supported on the support element. The first and second angles are different from each other. The base may include movable weight that is connected with the base and movable with respect thereto between the first base surface and the second base surface.

### CROSS-REFERENCE TO RELATED APPLICATIONS

The present application is co-pending with U.S. patent application Ser. No. 14/937,280 entitled “MOBILE DEVICE SUPPORT WITH FINGER CLEARANCE,” which is incorporated herein by reference in its entirety.

### TECHNICAL FIELD

Disclosed herein is a support structure; more particularly, the support structure is a mobile device support for positioning mobile devices at viewable angles on underlying surfaces.

### BACKGROUND

Modern mobile electronic devices particularly ones suitable to be handheld are capable of accessing and delivering vast amounts of different types of media and information. The overall usefulness of these devices has made them ubiquitous in everyday life. As such, users of these devices have incorporated them into their lifestyle. While many interactions with a mobile device are, as the name would suggest, optimized by holding the device in one or both hands, some interactions are improved by outsourcing the physical support of the device to an independent support structure. Such outsourcing allows a user to maintain a hand-like viewing angle of the device without needing to hold it, thereby freeing the user to perform other one and two-handed tasks. (E.g. cooking, eating, drawing, building, playing an instrument, etc.) Support structures, however, are often cumbersome to use and frequently provide inadequate device support and/or viewing angles. These shortcomings can needlessly damage the user experience, either by delaying the start of a user's interaction with their device (prolonged setup/take-down time, etc. . . . ), or otherwise, interrupting, or diminishing from the ongoing multitasking experience. Known support structures rely on shelves, clasps, clamps, straps, special cases, or other hardware to hold the devices in place. Additionally, traditional devices rely on complicated joints to position the device at different angles. Such joints include ball and socket joints to adjust angles. Clamps then secure the position.

Additionally, traditional gravity-based support structures are limited in the versatility and usefulness of the orientations in which the mobile devices can be positioned thereon. In one example, U.S. Pat. Pub. No. 2013/0299668 illustrates a stand that provides more than one display angle, but the center of gravity of the stand remains the same regardless of position and no portion of the stand is able to hang out beyond the stand's support surfaces. Not having any portion of the stand hanging out beyond the stand's support surface limits the angle between the support surfaces to, at most, 90 degrees. A 90 degree angle limitation between the bases in turn limits the sum of the potential display angles to, at minimum, 90 degrees at least with regards to triangular stands that have angles that equal 180 degrees. This results in undesirable display angles such as a small angle and a large angle (e.g. 30 degrees and 60 degrees), the latter of which would result in insufficient base support for normal device use, and/or is too steep of an angle for normal use, or angles that are both close to 45 degrees (e.g. 42 degrees and 48 degrees) which results in similar angles that are not reclined enough for optimal device viewing while the user is standing at a countertop.

In light of the various shortcoming of known stands discussed herein, improved devices that overcome these, as well as other shortcomings, are desirable.

### SUMMARY

A mobile device support is provided herein. The support may include a support element that supports a mobile device and a multi-positionable base on which the support element is mounted. The mobile device support may be configured to accommodate various mobile devices including phones, tablets, e-readers, and similar devices. The base may include a first base surface disposed at a first angle with respect to the support element. The first base surface is operable to rest on an underlying surface to position the support element at the first angle while the mobile device is supported on the support element. The base may include a second base surface disposed at a second angle with respect to the support element. The second base surface is operable to rest on the underlying surface to position the support element at the second angle while the mobile device is supported on the support element. The first and second angles are different from each other. The base may include a movable weight that is connected to the base and movable with respect thereto between the first base surface and the second base surface. In response to repositioning the base so that the first base surface is resting on the underlying surface, the movable weight operably moves over the first base surface further from the second base surface, thereby increasing the stability of the device support with the support element at the first angle. In response to repositioning the base so that the second base surface is resting on the underlying surface, the movable weight operably moves over the second base surface further from the first base surface, thereby increasing the stability of the device support with the support element at the second angle.

In accordance with various embodiments, the first base surface defines a first contact plane, and the second base surface defines a second contact plane at an angle to the first contact plane. The weight is movable with respect to the support element. The base includes a cavity defined in part by a first wall in which a first side of the first wall is the first base surface and a second wall in which a first side of the second wall is the second base surface. The underlying surface may be horizontal.

In accordance with various embodiments, the base may rest on the underlying surface by gravity. The weight may move within the cavity by gravity. The movable weight may be a fluid material. Alternatively, the movable weight may be one or more of solid or semi-solid articles. The solid or semi-solid articles may include a plurality of articles operable to move independently of one another, forming a particulate material. The solid material may include one or more rolling elements.

In some embodiments, the first and second base surfaces comprise toe ends, which are disposed distally from each other, and comprise heel ends, which are disposed adjacent or proximally to each other, with the heel ends defining a heel region of the device support. The heel region can be off center from the support element. The heel region can be substantially contiguous, forming a peak between the first and second base surfaces. The movable weight can move in the direction of the first toe end in response to the first base surface resting on the underlying surface, and in the direction of the second toe end in response to the second base surface resting on the underlying surface. The support element may include a first support element surface and a second support element surface positioned in substantially the same plane as each other. The first support element surface and the second support element surface may be spaced from each other. The first and second support element surfaces may be disposed distally from each other such that the first and second support element surfaces are operable to support opposite ends of the mobile device. The first and second support element surfaces may have a longitudinal separation there between such that a user's hand can access a back side of the mobile device. The support element supports the mobile device by gravity.

### BRIEF DESCRIPTION OF THE DRAWINGS

The drawing figures depict one or more implementations in accordance with the present concepts, by way of example only, not by way of limitations. In the figures, like reference numerals refer to the same or similar elements.

FIG. 1 is a perspective view of a mobile device support in accordance with an exemplary embodiment.

FIG. 2 is a front view of the mobile device support of FIG. 1;

FIG. 3 is a side view of the mobile device support of FIG. 1;

FIG. 4 is a front top view shown through a mobile device positioned on a support surface on the mobile device support of FIG. 1;

FIG. 5 is a rear view of the mobile device support of FIG. 1;

FIG. 6A is a side cross-section view of the mobile device support of FIG. 1 taken along cross-section line A-A shown in FIG. 2 with the first example of a weight;

FIG. 6B is a side cross-section view of the mobile device support of FIG. 1 taken along cross-section line A-A shown in FIG. 2 shown with a second example of a weight; and

FIG. 6C is a side cross-section view of the mobile device support of FIG. 1 taken along cross-section line A-A shown in FIG. 2 shown with a third example of a weight.

### DETAILED DESCRIPTION

A mobile device support is provided herein. The mobile device support may be configured to support a mobile device via a support element at an elevated position or inclined angle above a support surface such as a table, desk, or countertop. The mobile device may include any handheld device such as smart phones or larger devices such as tablets (other types of devices or non-electronic media, e.g. books, may be usable as well.) The mobile device may include protective or decorative covers as well. While, discussed in terms of being mounted on a horizontal surface herein, the mobile device may be mounted on non-horizontal surfaces as well. The device could be used with other bracketing systems to be mounted on substantially vertical surfaces as well. The support may limit the movement of the mobile device when the mobile device is positioned on the support element. The interface between the mobile device and the support may be caused by the mobile device resting on the support element by gravity. Other known interactions and devices may also replace or supplements the interface caused by gravity. The support element can limit movement of the mobile device and retain the interface and engagement by friction. The support may also include a multi-positionable base on which the support element is mounted. The base may provide at least two angles at which a viewer can view a mobile device when mounted on the support element and when the base is seated on a horizontal surface. The first angle may be optimized for when the user is seated, such as at a desk. The second angle may be optimized for when the user is standing, such as at a countertop. The support may include an internal cavity which houses a movable weight. The movable weight may be operable to shift within the cavity as the support is repositioned from the first viewing angle to the second viewing angle. The cavity may be shaped to facilitate a quick and complete transition of the moveable weight. Additionally, the cavity may be shaped to promote the congregation or “pooling” of weight in areas that increase support stability. This shift in the movable weight may shift the center of gravity of the support such that the support is more stable in each position due to the shift in center of gravity as opposed to a similar geometry having a non-shifting center of gravity. In this way, the stability of the support may be maximized in each of the support's positions, allowing for improved access to and use of various mobile devices. Various embodiments of the mobile device support are discussed in more detail herein.

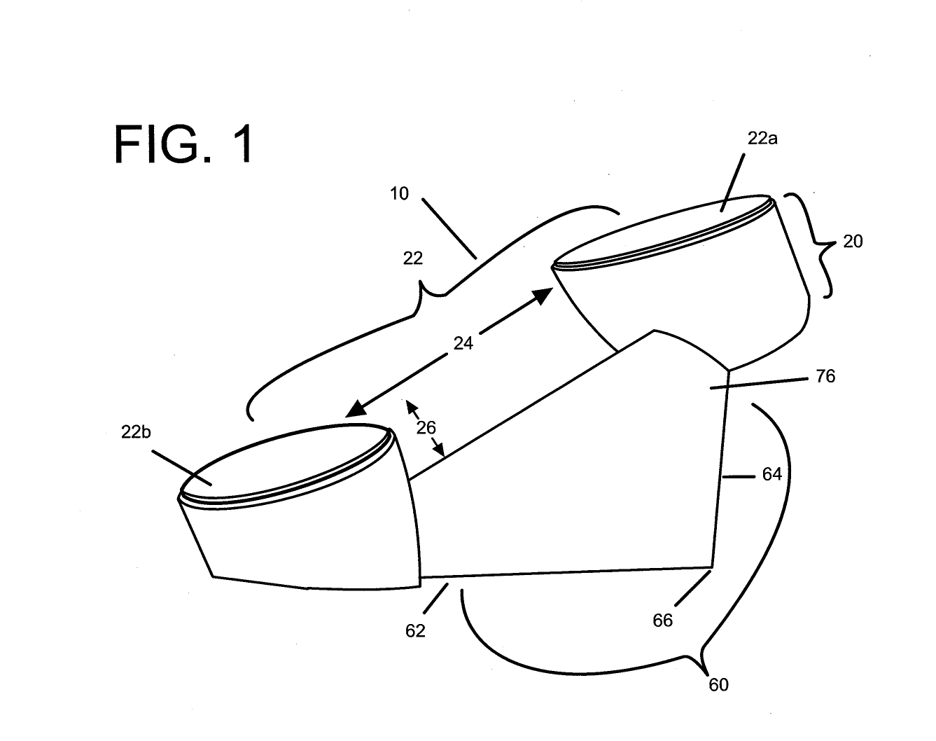

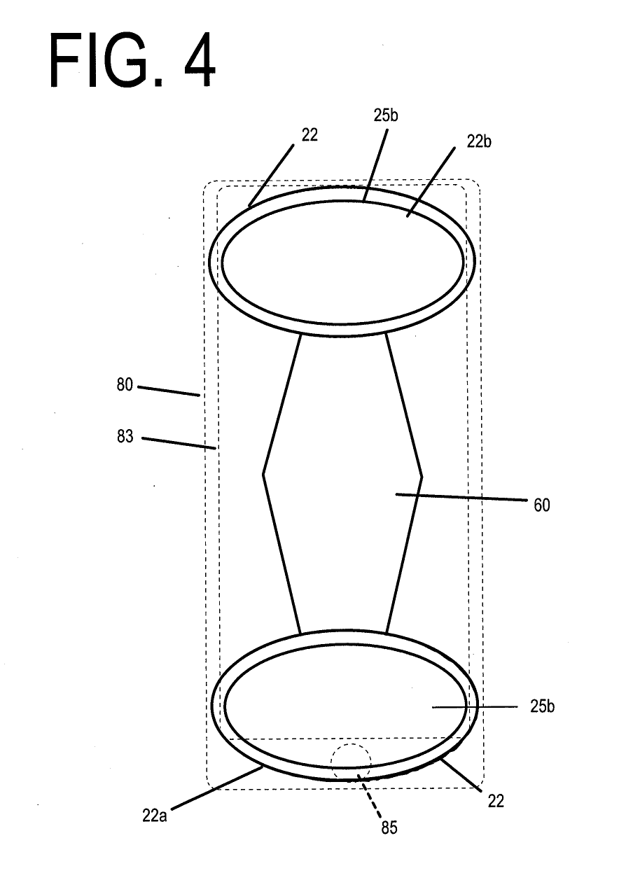

As illustrated in FIG. 1, a mobile device support 10 may include a support element 20 and a base 60. The support element 20 and the base 60 may be contiguous and formed as a unit, such as integral parts or a unitary structure. They may alternatively be separate components that are joined together to form the handhold device support 10. The support element 20 may include a support surface 22 operable to position a mobile device thereon. The mobile device may be only a handheld device or it may be a handheld device with a cover or other similar accessory. The support element 20 may be sized to offer suitable support for usage of the entire front face of the device. “Usage” of the front face 83 of the device 80 (see e.g., FIG. 4) in this context may include, for example, a user pressing with one or more fingers on a real or virtual button on the face 83 of the device, such as the “home” button 85, aggressively tapping (for instance in gaming applications, music applications such as drumming interactions, etc.), swiping, typing, or applying other force to the face 83 of the device to effect an input or interact with the device. Providing the suitably sized and configured support allows the user to press with one finger without having to pinch the mobile device with a second finger or to hold it on the support with another hand. Support element 20 may be sized to adequately support a mobile device in landscape orientation independently, or paired with support surface 22b to support a mobile device in portrait orientation.

The support surface (or surfaces) may be positioned to provide support not only to the sides (i.e. transverse support) and ends (i.e. longitudinal support) of the mobile device, but also to the middle of the device near the bottom edge of the device. This location is where a mobile device's “home button” 85 is sometimes located. Such support may allow for full front-face mobile device usage that includes actuating the “home” button with a single finger push. The support surface(s) may include rounded edges, such as to increase comfort to a user whose hand may come in contact with them, or may be angular. FIG. 4 illustrates an example of the longitudinal and transverse support of surface 22 (or as shown in the figure, a plurality of support surfaces 22a, 22b) relative to an example of mobile device 80 shown in dotted line. In this embodiment the areas 83 of the mobile device that may encounter virtual button manipulation (e.g., presses or swipes) or physical manipulation (e.g., the home button 85) are fully supported by the longitudinal length of the support surface 22 and the transverse width of the support surface 22. The overall supportive length and width of surface (or surfaces) 22 may provide support to the corner regions (i.e. near the corners) of the mobile device 80. While the support surface(s) may not extend entirely to the very corners of the mobile device 80, the longitudinal extent and the transverse extent of the support surfaces(s) may provide sufficient support to the corner regions of the mobile device such that virtual or physical buttons in those areas are can still be utilized.

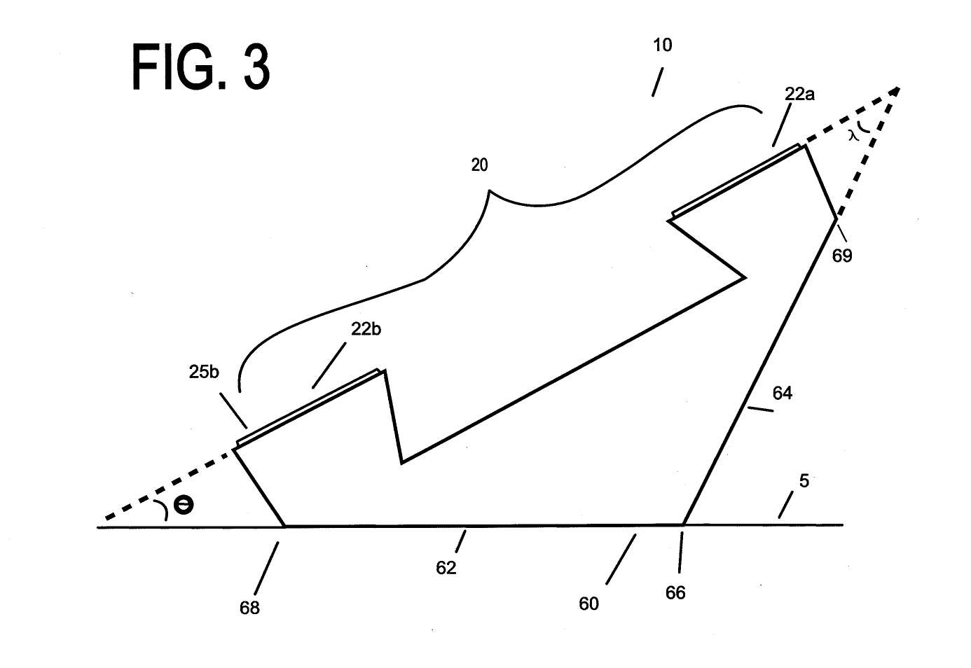

While shown in the exemplary figures as being elongated in the longitudinal direction (i.e. the direction shown to provide an inclination for support of the mobile device in FIGS. 1, 2 and 6), the device support 10 accommodates both portrait and landscape positions of mobile device orientations. Full front-face support may be on only one or the other orientations. For example, in landscape orientation the support 10 may only provide support to engage in normal usage (e.g., swipes, taps, etc.). In this orientation a user may support home button presses with a pointer finger and thumb (as one does when holding a device in one's hand). However, in other embodiments, the support surfaces may be positioned transversely as opposed to laterally as shown in the FIGS. 1-6. With the support surface 22 extended or positioned transversely, a one finger press of the functionality button (e.g., “home” button) may be possible as the transverse sides of the mobile device would be supported, thereby supporting the home button in a landscape mode. In such an embodiment, the one finger pressing might be avoided in the portrait orientation of the mobile device.

In accordance with various embodiments, the support surface 22 may be a single or multiple surfaces. In one example of a multiple surface embodiment, the support element 22 may include a first support element surface 22a and a second support element surface 22b. The two surfaces may be separate support surfaces 22a, 22b. The first support element surface 22a and the second support element surface 22b may be positioned in substantially the same plane. The first support element surface 22a and the second support element surface 22b may be spaced apart from each other. For example, the first and second support element surfaces 22a and 22b may be disposed distally from each other such that the first and second support element surfaces 22a, 22b are operable to support opposite ends of the mobile device. The first and second support element surfaces 22a, 22b may have a longitudinal separation 24 therebetween with sufficient depth 26 to allow a user's finger or hand to access a back side of the mobile device. The FIGS. 1-6 merely represent one example for the structure of the support surface 22, however. The support surface 22 may be a singular continuous surface, two separate surfaces (as shown), or can be comprised of three or more separate surfaces.

In various embodiments, the device support 10 widths are less than that of the mobile device, allowing invisibility of the support device 10 when the mobile device is placed thereon. This also allows for the support device 10 to be minimized with regard to the support device's footprint improving portability and space considerations. In one example, the first and second support element surfaces 22a, 22b have a width at least 50% the width of the mobile device. More particularly, the first and second support element surfaces 22a, 22b may have a width that is at least 85% the width of the mobile device. In various embodiments, the first and second support element surfaces 22a, 22b has a width that is less than 99% the width of the mobile device. More particularly, the first and second support element surfaces 22a, 22b has a width that is less than 95% the width of the mobile device. In accordance with various embodiments, the support device 10 (including the support element 20 and or the base) is at least as wide as the screen (i.e. extends at least as wide as bezel outside of the screen). In accordance with alternative embodiments, the bounds of the support device 10 (i.e. the lateral width and longitudinal length) extends to or beyond the edges of the mobile device (i.e. the support element 20 is at least than 100% of the mobile device). This particular structure increases stability.

In accordance with various embodiments, the first and second support element surfaces 22a, 22b may have an aspect ratio of their width (i.e., width across each surface) to their length (i.e., the length from the longitudinal extreme of one surface such as 22a to the other surface 22b) that substantially matches or is less than the aspect ratio of the mobile device used therewith. For example, the mobile device may have an aspect ratio may be approximately 2.64 in. width to 5.44 in. length matching the aspect ratio of an iPhone 6. In this embodiment, an aspect ratio may be less than 2.64 in. width to 5.44 in. length allowing for the mobile device to obscure the support device 10.

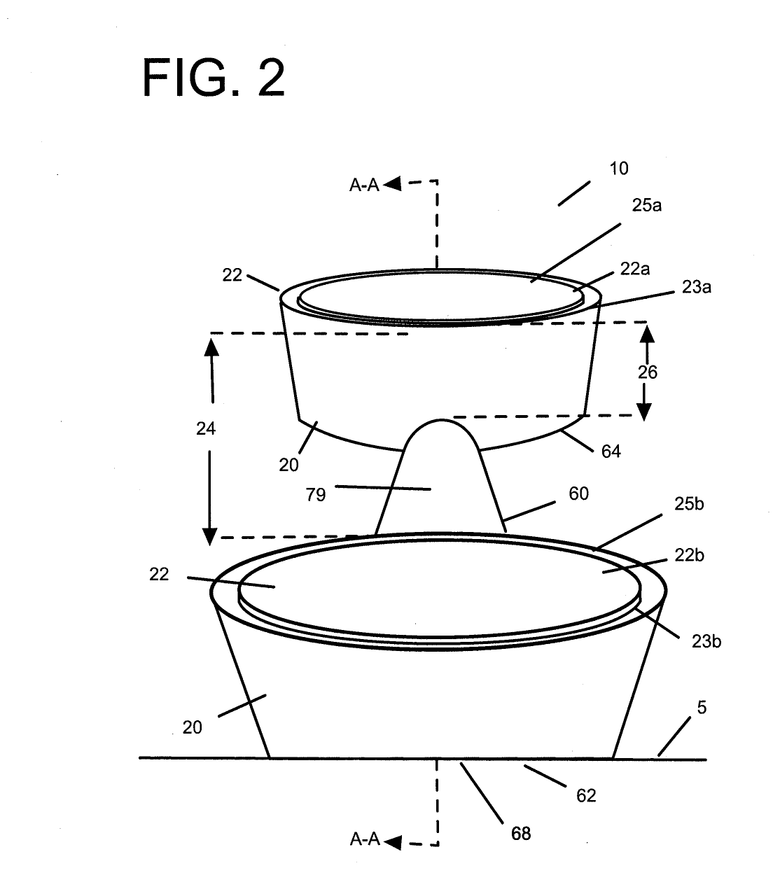

The support surface 22 may be formed in any shape, but as stated above is preferably formed in a shape that provides support to the ends and sides of the mobile device. In one example, as shown in FIG. 2, the support surface 22 may be formed with any suitable shape. In the embodiment shown, the support surface is formed as two, flat, elliptical-shaped surfaces 22a, 22b which cooperatively support the mobile device placed resting thereon, although other shapes that provide suitable support may also be utilized.

The mobile device support 10 may also be configured in accordance with the various embodiments recited in the incorporated reference. A person of ordinary skill in the art will appreciate that each of the various embodiments disclosed herein or in the incorporated reference may be utilized together, separately, or in any combination whether explicitly recited herein or not.

When placed on a horizontal surface 5, the base 60 of the support 10 limits movement of the mobile device relative to the horizontal surface 5. As discussed above, the support element 10 offers suitable support for usage of the entire front face of the device. During usage of the mobile device, the base 60 limits movement of the mobile device relative to the underlying surface 5 despite pressure from the user against the front faces of the device. The base 60 may be any structure suitable to support a mobile device via the support element 20. When used on a horizontal surface 5, the support 10 can display the mobile device in a plurality of different orientations. The base 60 may include a plurality of base surfaces 62 and 64, each being operable to support the support 10. The base surfaces 62, 64 may be generally flat (i.e. provide a planar contact with the underlying surface) or the surfaces may be defined complex shapes (e.g., having protrusions or the like extending therefrom) that are configured to be in contact with the underlying surface at discrete points or discrete lines as opposed to a planar contact. Each of the plurality of base surfaces (e.g., 62, 64) may provide sufficient contact with the underlying surface such that each of the plurality of base surfaces 62, 64 limits longitudinal rocking or transverse rocking of the mobile device when the outer edges of the mobile device's screen are pressed during usage. For example, the base surfaces 62,64 may have three or more points which contact the underlying surface 5 at sufficient transverse widths to limit the side-to-side rocking and at sufficient lengths to limit end-to-end rocking. The widths may be approximately the same width as the width of the mobile device and the length may be approximately the same length as the mobile device. In other embodiments, the base surfaces 62 and 64 are at least 50% the width of the mobile device. More particularly, the base surfaces 62 and 64 is at least 85% the width of the mobile device. In various embodiments, the base surfaces 62 and 64 are less than 99% the width of the mobile device. More particularly, the base surfaces 62 and 64 are less than 95% the width of the mobile device.

The first base surface 62 may define a first contact plane. The plane may be defined by the three or more contacts between the first base surface 62 and an underlying flat surface (e.g., surface 5). Similarly, the second base surface 64 may define a second contact plane. The second contact plane may be defined by the three or more contacts between the second base surface 64 and an underlying flat surface (e.g., surface 5) when positioned thereon. The second contact plane may be at an angle relative to the first contact plane. The angle between the two contact planes may be an obtuse angle. While it is understood that contact points of each of the first and second surfaces 62 and 64 define their contact planes and while the first and second surfaces 62 and 64 may be generally planar or may have complex surfaces that can include protrusions configured to contact the underlying surface 5, these general concepts will be encompassed by and referred to herein by the terminology of base surface. While the surfaces themselves may be complex, the orientations of the base surfaces discussed below refer to the orientation of the contact plane defined by the base surface as described above.

As illustrated in FIG. 2, the first base surface 62 may be operable to rest on an underlying surface 5 and position the support element at a first angle θ with respect to the support element 20 while the mobile device is supported on the support element 20. The base 60 may include a second base surface 64 disposed at a second angle λ with respect to the support element 20. The second base surface 64 is operable to rest on the underlying surface 5 to position the support element 20 at the second angle while the mobile device is supported on the support element. The first and second angles are different from each other. The first base surface 62 may be disposed at a first angle θ. The second base surface 64 may be disposed at a second angle λ with respect to the support element 20. The first angle θ may be a smaller angle than the second angle λ. The first angle θ may be suitable for viewing the screen of a mobile device when the mobile device is positioned below the user. For example, the mobile device may be positioned below a user when the user is standing and the device is positioned on a table, countertop, or other horizontal surface 5. The second angle λ may be steeper than the first angle θ. The second angle λ may be suitable for viewing the screen of a mobile device when the mobile device is positioned nearer to the eye level of the user. In one example, the first angle θ is at least 15°. More particularly, the first angle θ is at least 20°. In various embodiments, The angle θ is less than 45°. More particularly, the angle θ is less than and 30°. In a preferred embodiment, the first angle θ is approximately 29°. In various embodiments, the second angle λ is at least 15°. More particularly, the second angle λ is at least 30°. In various embodiments, the second angle λ is less than 45°. More particularly, the second angle λ is less than 40°. In one preferred embodiment, the second angle λ is approximately 38. In various other embodiments, other angles may be applicable and are used. In accordance with various embodiments, the two angles add up to less than 90 degrees.

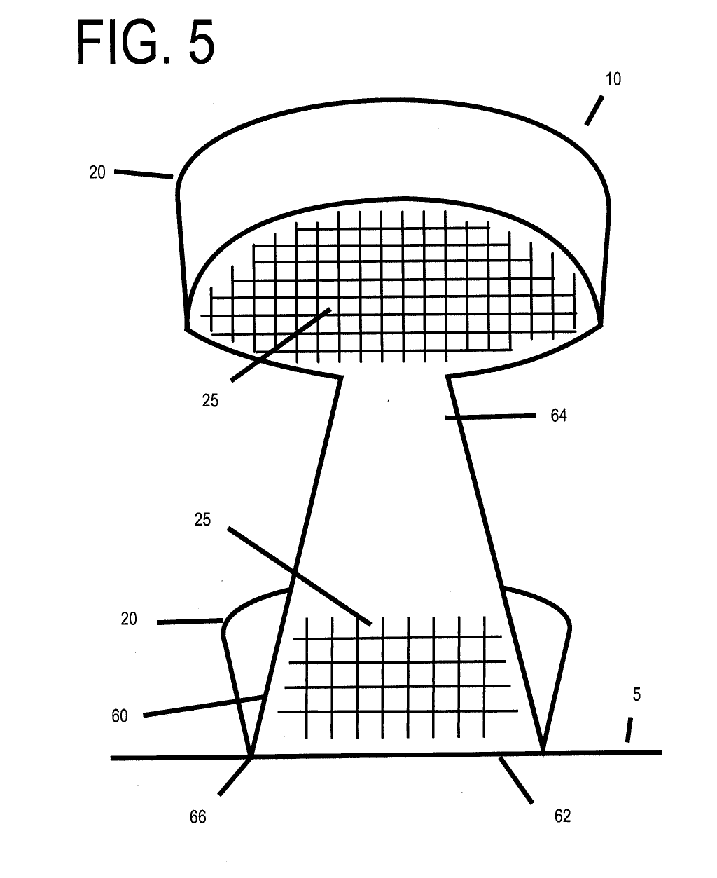

In one embodiment, as illustrated in FIGS. 1-6, the first and second base surfaces 62 and 64 have toe ends 68 and 69 respectively. The toe ends 68 and 69 are disposed distally from each other at the longitudinal ends of support 10. Each of the base surface 62 and 64 may also include heel ends that are disposed adjacent each other. The heel ends may define a heel region 66 of the device support. The heel region 66 may be located off center from the support element. As illustrated in FIGS. 1, 2, and 5, the base 60 may be wide at the heel region 66 and taper down toward each of the toe ends 68 and 69 and then widen out immediately proximate to the toe ends 68 and 69 at the support elements 22. In this configuration, the base surfaces 62 and 64 may provide transverse support at the heel region 66 (see FIG. 5) and the toe regions 68 and 69 while accommodating a lower profile there between. In some embodiments, the heel region 66 may be substantially contiguous, forming a peak between the first and second base surfaces 62 and 64.

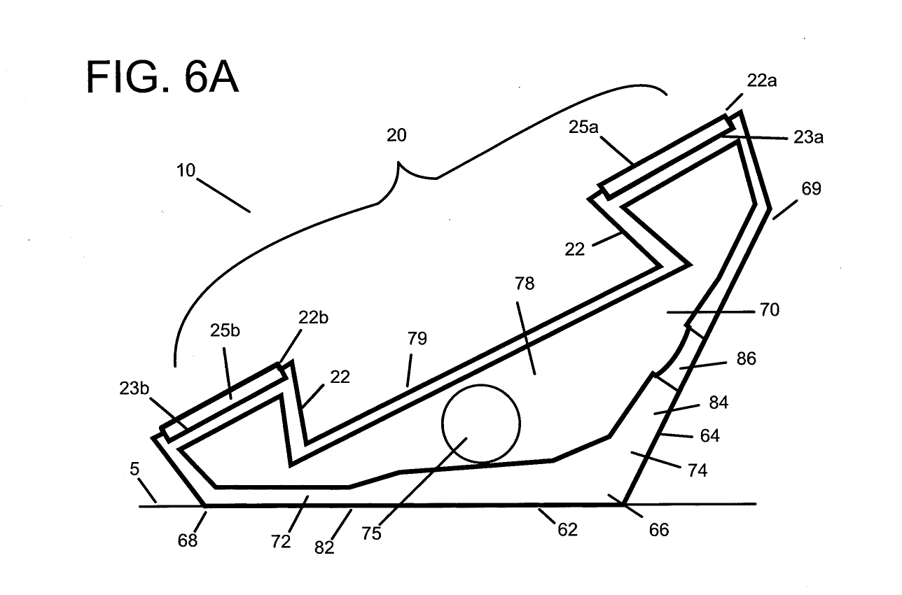

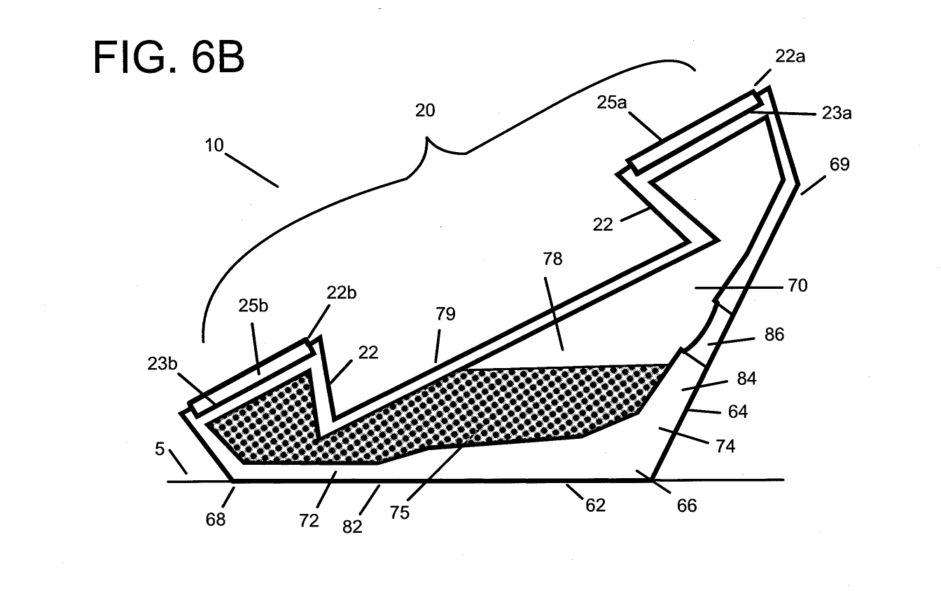

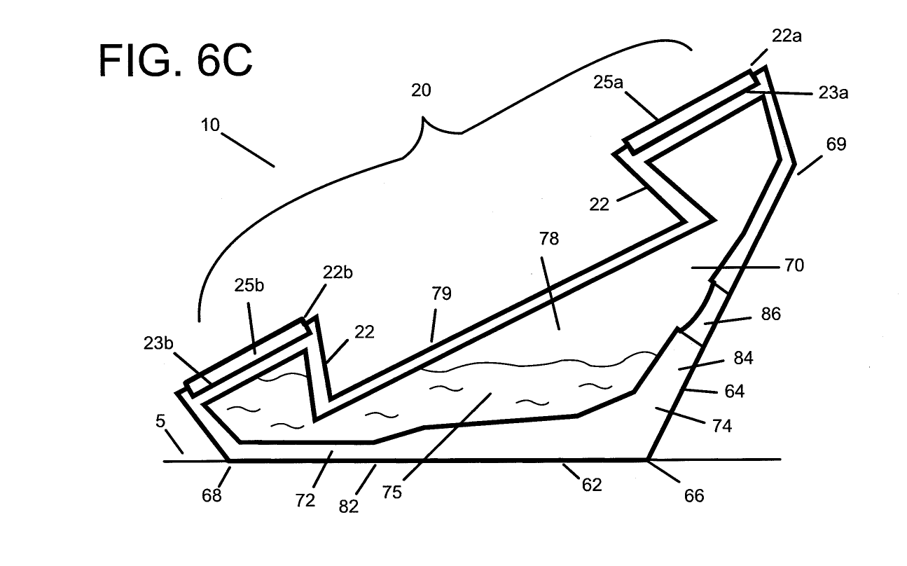

As illustrated in FIG. 6A, the base 60 may include an internal cavity 70 that is defined by the volume formed by a plurality of walls. The base 60 may include a first wall 72 that is defined on one side by base surface 62. The base 60 may include a second wall 74 that is defined on one side by base surface 64. The first and second walls 72 and 74 define two of the walls of the plurality of walls that define cavity 70. In various embodiments, these two walls 72 and 74 may connect at heel region 66. In various embodiments, two additional walls 76 and 78 may extend from these two walls and connect at ridge 79. While the plurality of walls illustrated in FIGS. 1-6 may define a shape of the interior cavity 70, it may be appreciated that the interior cavity may have any of a variety of shapes suitable to contain movable weight 75 The cavity 70 may be asymmetrical. For example, since the first base surface 62 is at a different angle relative to the support surface 22 than the second base surface 64, the geometry of the different portions of the cavity proximal to these separate base surfaces may be different in volume and/or shape. The cavity may also include an access aperture 86 through the wall to fill, empty, or change the internal components such as a moveable weight 75.

A movable weight 75 may be located within the cavity 70. The movable weight may be operable to move from a first weight surface 82 and a second weight surface 84. The first weight surface 82 may be defined on the wall 72 opposite base surface 62. The second weight surface 84 may be defined on the wall 74 opposite base surface 64. The weight 75 may move in the direction of the first toe end 68 in response to the first base surface 62 resting on the underlying surface 5. The weight 75 may move in the direction of the second toe end 69 in response to the second base surface 64 resting on the underlying surface 5. The cavity 70 may be shaped to facilitate a quick and complete transition of the moveable weight 75. Additionally, the cavity may be shaped to promote the congregation or “pooling” of weight in areas that increase support stability.

The weight 75 may bias the support 10 in position regardless of what angle of support surface 22 is selected. To alternate between angles, a user may rotate the mobile device support 10 about the heel region 66. As the user rotates the mobile device support 10, the weight 75 moves to the new location proximal the surface in contact with the underlying surface 5. In the new location, the weight has shifted the center of gravity to bias the mobile device support 10 in the new position. This angle changing method allows a user to alternate between device viewing angles without tightening, loosening, or reconfiguring individual parts, but still maintain a sturdy base with the center of gravity shifted over the surface in contact with the underlying surface 5. This system also allows for the base 60 and support element 20 to be configured in such a way that a significant portion of the base 60 and/or support element 20 hangs out over the underlying surface 5 without the base surface being directly thereunder. This structure allows each of the display angles to be less than 45 degrees.

The movable weight 75 may be a fluid material (see e.g., FIG. 6C), in which case the cavity 70 may be sealed against leakage of the fluid. For example, aperture 86 may be capped to add or remove fluid. The fluid material may include water, gel, or other denser-than-air fluid that is sufficiently heavy or dense liquids to effectively shift the center of gravity to increase stability of the base surfaces 62 and 64. In another embodiment, the movable weight 75 may be a solid material. The solid material may include one or more separate solid articles that are operable to move independently of one another forming a particulate material as shown, for example, in FIG. 6B. The particulate material may include any materials that are solid or semi-solid and operable to flow from one point to another under gravity within the cavity. Examples of particulate material may include sand, beads, ball bearings, etc. In instances having a small number of separate solid articles, the solid articles may similarly be operable to move from one location to another under gravity. One example of a solid article that is operable to move from one location to another under gravity includes a rolling element, such as a ball shown in FIG. 6. It may be appreciated that any material of any shape may be used. In some embodiments, such as those using particulate material of liquids, a bladder may be positioned within the cavity to contain the liquid.

In accordance with various embodiments, the support device 10 may include one or more high-traction elements 25. High traction may be used herein to define a limit slip characteristic between components such that in a static state the traction is sufficient to prevent movement of the mobile device relative to the support device 10 or the support device 10 relative to the underlying surface 5 during normal usage (e.g. single finger operation discussed above) of the mobile device when positioned on the support device 10. In various examples, the support element 20 and base 60 may be formed from a first material. The high traction element 25 may be a second material that is applied to the support element 20 or the base 60. For example, the high fraction element 25 may be formed on one or more of the support surface(s) 22 (e.g. 22a, 22b) on the support 20 or on the base surface 62, 64 on the base 10. The high traction element 25 may provide a desirable level of cushioning reducing impact or sound when placing the mobile device on the support 10 but still enable full utility of the actual and virtual buttons on the mobile device. Additionally, element 25 may also provide increased traction between the mobile device and the support 10 as compared to the traction that would occur between the mobile device and the example first material from which the rest of the support 10 is made. As used herein, the term fraction may apply to any interaction between devices limits or prevents slippage via any type of interaction. Specifically, the high-traction element 25 may limit the mobile device's movement parallel and relative to the support surface 22, perpendicular movement (i.e. lifting the mobile device off of the mobile device support 10) remains unhindered. For example, the traction member 25 may allow the mobile device to be positioned on the support device 10 at an inclined angle with respect to the horizontal or parallel with respect to the horizontal and still be fully utilized. The high traction properties of the traction member 25 may be present regardless of the shape of the support element 20 or base surfaces 62, 64. In some examples, the second material may be a tacky material in which some perpendicular movement may be resisted as well. In various examples, suitable materials for the traction element 25 include an elastomer, such as a rubber or elastomeric polymer. In various examples, the elastomeric polymer is a soft elastomer such as silicone rubber attached with an acrylic adhesive. An example of the type of silicone rubber surface is Egrips® such as can be found at http://www.egrips.com/. In other examples, the elastomeric polymer is expanded vinyl material or a polyurethane material. Examples of such materials are disclosed in U.S. Pat. Nos. 6,673,409; 7,125,602; and 7,252,867. In various embodiments, the support element 20 and the base surfaces 62, 64 have the same traction element 25. In alternative embodiments, the support element 20 and the base surfaces 62, 64 are different traction elements 25. For example, the support element 20 includes the silicone rubber traction element and the base surfaces 62, 64 include the expanded vinyl material or a polyurethane material.

The support surface(s) may also include recesses 23a, 23b with a depth that is approximately the same as or less than the thickness of the non-slip, anti-slip element, or high-traction pad 25a, 25b, so that the traction element 25 extends proud of a ridge surrounding the recess.

The support element(s) may include gaps or cutouts that create space for a mobile device peripheral (e.g. the camera lens of the iPhone 6 extends proud above the phone's back surface.) Cutouts or gaps may be included in the surface as needed to allow various devices to rest fully flat upon the support surfaces.

In various embodiments, the high-traction element 25 may be a contiguous portion of support device 10 (e.g., on the base surface 62, 64 or on the support surface 22a, 22b). As applied to any of the contact surfaces (i.e. surfaces contacting the mobile device or the underlying surface), the high-traction element 25 can be a textured surface sufficient to further increase traction as shown by way of example on the base surface 64 in FIG. 5. In this manner the traction element may be a high friction element, with high-friction denoting an elevated coefficient of friction. Some embodiments, the various surfaces of support device 10 that contact the mobile device or the underlying surface may be generally smooth.

In accordance with various embodiments, the mobile device support 10 may be heavy enough to create the friction to limit movement when in use. However, the mobile device support 10 may remain light enough to be portable, allowing a user to carry it easily between locations in one's hand, or in a large pocket or bag.

The device support 10 may be sufficiently small, including the base 60 and the support element 20, to entirely hide the device behind the mobile device when the mobile device is positioned thereon. When a mobile device is placed on the mobile device support 10, the mobile device support 10 may be sufficiently small to be invisible to the device user, giving the appearance that the device is floating. This invisibility may be present in any viewing angle discussed herein. Each base may be configured to provide support while minimizing mobile device support 10 visibility. For example, the mobile device support 10 may be narrow enough and short enough to be fully obscured when viewed from the vantage point of the device user.

Any and all references specifically identified in the specification of the present application are expressly incorporated herein in their entirety by reference thereto. The term “about,” as used herein, should generally be understood to refer to both the corresponding number and a range of numbers. Moreover, all numerical ranges herein should be understood to all numbers within the range.

All relative and directional references (including: upper, lower, upward, downward, left, right, leftward, rightward, top, bottom, side, above, below, front, middle, back, vertical, horizontal, height, depth, width, and so forth) are given by way of example to aid in understanding of the particular embodiments described herein. They should not be interpreted to be requirements or limitations, particularly as to the position, orientation, or use of the invention unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

While illustrative embodiments of the invention are disclosed herein, it will be appreciated that numerous modifications and other embodiments may be devised by those skilled in the art. For example, the features for the various embodiments can be used in other embodiments. Therefore, it will be understood that the appended claims are intended to cover all such modifications and embodiments that come within the spirit and scope of the present invention.

1. A mobile device support, comprising:
a first base surface at an obtuse angle to an adjacent second base surface;
a third surface adjacent to and at an obtuse angle to said first base surface and an angle to a first support element;
a fourth surface adjacent to and at an obtuse angle to said second base surface and an angle to a second support element;
wherein said first support element and said second support element are spaced apart from each other; and
a movable weight resides within the base and is movable with respect thereto, such that:
in response to the first base surface resting on the underlying surface, the movable weight moves over the first base surface further from the second base surface, thereby increasing the stability of the device support with the first support element and second support element at the first angle, and
in response to the second base surface resting on the underlying surface, the movable weight moves over the second base surface further from the first base surface,
thereby increasing the stability of the device support with the first support element and the second support element at the second angle.

2. The mobile device support of claim 1, wherein the first base surface defines a first contact plane and the second base surface defines a second contact plane at an angle to the first contact plane.

3. The mobile device support of claim 1, wherein the weight is movable with respect to the first support element and the second support element,
and the first support element and the second support element are spaced apart from each other.

4. The mobile device support of claim 1, wherein the base includes a cavity defined in part by a first wall in which a first side of the first wall is the first base surface and a second wall in which a first side of the second wall is the second base surface.

5. (canceled)

6. (canceled)

7. The mobile device support of claim 1, wherein the underlying surface is horizontal.

8. The mobile device support of claim 1, wherein the movable weight is a fluid material, and said fluid material fills a space between one of said first base surface and said second base surface and a respective one of said first support element and said second support element while air fills at least some of a space between said fluid material and one of said second base surface and said first base surface.

9. The mobile device support of claim 1, wherein the movable weight is one or more of solid articles, and whether said first base surface or said second base surface is at a gravitational bottom of said mobile device support, only one of a space between:
a) said first base surface and said first support element; and
b) said second base surface and said second support element;
is filled with said fluid material.

10. The mobile device support of claim 1, wherein the solid articles include a plurality of articles operable to move independently of one another and which are particulate material.

11. (canceled)

12. (canceled)

13. (canceled)

14. The mobile device support of claim 1, wherein the movable weight: moves in the direction of the first toe end in response to the first base surface resting on the underlying surface, and moves in the direction of the second toe end in response to the second base surface resting on an underlying surface.

15. The mobile device support of claim 1, wherein the support element comprises a first support element surface and a second support element surface positioned in substantially a same plane and spaced from each other with a trapezoidal depression defined by a first side wall and second side wall, each extending at an acute angle to a respective said first support element and said second support element to a base which lies in a plane parallel to the plane of the first support element surface and the second support element surface.

16. The mobile device support of claim 15, wherein the first and second support element surfaces are disposed distally from each other such that the first and second support element surfaces are operable to support opposite ends of the mobile device.

17. The mobile device support of claim 14, wherein the first and second support element surfaces are spaced apart with a depression formed there-between with a base of said depression in parallel with the first and the second support elements surfaces.

18. (canceled)

19. The mobile device support of claim 17, wherein the support element includes a high traction member with sufficient traction to prevent the mobile device from sliding off the support element under the mobile device's weight.

20. The mobile device support of claim 17, wherein the base surface includes a high traction member with sufficient traction to prevent the mobile device from sliding along the underlying surface in response to a user utilizing the mobile device.

21. The mobile device support of claim 1, wherein an angle between said second support element and said second base surface is less than 40 degrees.

22. The mobile device support of claim 21, wherein an angle between said second support element and said second base surface is 38 degrees.

23. The mobile device support of claim 8, wherein shifting a gravitational bottom of said mobile device support from said first base surface to said second base surface, or from said second base surface to said first base surface causes said fluid material to fill up a space to a support element of said first and said second support elements which was previously unfilled.

24. The mobile device support of claim 1, wherein the angle between the third surface and the first base surface, and the fourth surface and the second base surface are different from each other.

25. The mobile device support of claim 1, wherein said third surface is at a right angle to said first support element and said fourth surface is at a right angle to said second support element.

26. The mobile device support of claim 1, wherein said mobile device support in its entirety is obscured from view from the vantage point of a user of a device resting on said first support element and said second support element.
